(19) United States
(12) Patent Application Publication
(10) Pub. No.: US 2010/0014564 A1
(43) Pub. Date: Jan. 21, 2010

(54) CONFIGURABLE FREQUENCY HOPPING SYSTEM AND METHODS

(75) Inventors: Kenneth Eskildsen, Great Neck, NY (US); Yijun W. Wang, Syosset, NY (US)

Correspondence Address: HONEYWELL INTERNATIONAL INC.;PATENT SERVICES, 101 COLUMBIA ROAD, P O BOX 2245, MORRISTOWN, NJ, 07962-2245, US

(73) Assignee: HONEYWELL INTERNATIONAL INC., Morristown, NJ (US)

(21) Appl. No.: 12/176,783

(22) Filed: Jul. 21, 2008

(51) Int. Cl. H04B 1/713

(52) U.S. Cl. 375/134; 375/133; 375/E01.037

(57) ABSTRACT

Disclosed is a method, system and apparatus for providing a configurable frequency hopping system that will accord with FCC mandated FHSS schemes while allowing different sensor and keypads types to communicate to a control panel or network node in the 902-928 Mhz frequency band on a single transceiver. More specifically comprising a plurality of FHSS profiles are disclosed, including a plurality of channels, each said plurality of channels having a predetermined channel spacing, a predetermined data rate, a frequency range, and a predetermined transmission power; and a FHSS determining unit for selecting an individual FHSS profile from said plurality of FHSS profiles according to a data type.

### FIELD OF INVENTION

The present invention relates to wireless security systems and more particularly to radio frequency communications in the industrial, science and medical (ISM) band and used in security and/or alarm systems.

### BACKGROUND OF INVENTION

Currently, there are a plethora of short-range radio technologies available that support wireless communications between a variety of devices in numerous environments. These short-range radio technologies typically take the form of embedded RE transceivers coupling to a device. Each device may have different communication ranges and data rate requirement complicating wireless communications. For example, embedded RF transceivers are found in conventional security systems such in as a control panel and a variety of sensors (e.g. motion, smoke and heat sensors) deployed throughout the home or business environment. As indicated above, each sensor might have a different communication ranges and data rate requirement based upon its type and function. For example, security system applications such as audio/video data transmission, (e.g. video PIR or alarm verification) might require a short communications range and data transfers at high data rates, while text based data transmission such as dtmf status or alarm report might require longer range and lower data rates.

In order to accommodate wireless communications among diverse devices such as a plurality of sensors in a security system, several frequency bands are available such as the 315-470 Mhz, 868-870 Mhz, 902-928 Mhz and 2.4 Ghz frequency bands. Of these enumerated frequency bands, the ISM band (902-928 Mhz) along with higher transmission power, offers a desirable increased frequency ranges and geographical coverage necessary for many implementations such as in a residential and business security system.

Current FCC rules regulate the use of the 902-928 Mhz frequency band by requiring frequency hopping spread spectrum (FHSS), a modulation scheme for transmitting radio signals by continuously switching a carrier among many frequency channels where a pseudorandom sequence known to both the transmitter and the receiver is transmitted. A FHSS scheme would have a set communication range and data rate requirement. For example, a sender transmits at one carrier frequency for a predetermined period of time, then hops to another carrier frequency for the same amount of time, and so on. After a predetermined number of hops, the cycle is again repeated.

Consequently, conventional wireless communications among diverse devices communicating on the 902-928 Mhz frequency band do not change FHSS schemes to accommodate each diverse device type with regards to their individual data transmission needs. Therefore, conventional wireless communications between a master device and peripheral devices are not optimized. Instead, a conventional master device must contain numerous RF transceivers to communicate with each differing peripheral device having differing data transmission needs. Accordingly, as discuss above in the case of a conventional security system, a control panel would require multiple transceivers to implement a FHSS schemes as well as accompanying control circuitry to implement a hopping scheme for each diverse sensor.

Hence, there is a need for a configurable frequency hopping system and method that will comply with the FCC mandated FHSS scheme that will allow different device types to communicate with a master device efficiently in the 902-928 Mhz frequency band using a single transceiver.

### BRIEF SUMMARY OF THE INVENTION

Accordingly, the present invention provides a configurable frequency hopping system and method that allow different sensor types in a security system to communicate with a master device in the 902-928 Mhz frequency band on a single transceiver.

Specifically, the present invention provides a configurable frequency hopping system (FHSS) for securing communications between a master device and a plurality of peripheral devices, comprising: a plurality of FHSS profiles, including a plurality of channel having a channel spacing, a data rate, a frequency range, and a transmission power; and a FHSS determining unit for selecting an individual FHSS profile from said plurality of FHSS profiles according to a data type and a required data rate of each said peripheral device and a communication range between said master device and each said plurality of peripheral devices, wherein the selection of said individual FHSS profile determines a communication path between the master device and each said plurality of peripheral devices.

In one embodiment of the present invention, the channel spacing, the data rate, the frequency range, and the transmission power of said first FHSS profile are configured to include 25 channels and to operate within a 400 Khz channel spacing scheme in the frequency range of 905.1-914 Mhz with a 140 Kbps data rate, a transmission power of 0.25 W.

In another embodiment of the present invention, the channel spacing, the predetermined data rate, the frequency range, and the transmission power of said second FHSS profile are configured to include 50 channels and to operate within a 200 Khz channel spacing scheme in the frequency range of 902-928 Mhz with a 100 Kbps data rate, a transmission power of 1.00 W.

In yet another embodiment of the present invention, the first FHSS profile provides (for securing one or more) text messages, and/or video and/or audio files communicated between at least one security control panel or a network node, and a plurality of peripheral devices at short ranges and higher data rates than said second FHSS profile and the second FHSS profile provides for (securing one or more )text messages communicated between at least one security control panel or a network node, and a plurality of peripheral devices at longer communication ranges and at lower data rates.

In a further embodiment of the present invention, a configurable frequency hopping (FHSS) method for securing communication between a master device and a plurality of peripheral devices in a security network, comprising the steps of: (1) randomly selecting and indexing a channel from among plurality of channels contained in a master hopping table in said master device, wherein each said channel is mapped to a plurality of predetermined frequencies contained in said master hopping table; (2) initializing a transmission of a synchronization request from said master device to each said plurality of peripheral devices according to a predetermined dwell time by transmitting the randomly selected and indexed channel to each said plurality of peripheral devices, wherein if said randomly selected and indexed channel is busy or if said predetermined dwell time elapse updating said master hopping list and incrementing said randomly selected and index channel and transmitting said synchronization request on the randomly selected and indexed incremented channel; (3) selectively, listening to a subset of said plurality of predetermined channels contained in said master hopping table, by each said plurality of peripheral devices and identifying if said randomly selected and indexed transmitted channel or incremented channel is contained in one or more device hopping tables in each said plurality of peripheral devices; (4) transmitting a response to said transmitted synchronization request, by each said identified peripheral devices by sending a device type to said master device, wherein said master device identifies said device type and updates said master hopping table based upon a data in each said identified peripheral devices; and (5) adjusting a data transfer rate between said master device and each said responding peripheral devices, by said master device, based upon said updated master hoping table; (6) incrementing said selected and indexed channel in said master hopping table and retransmitting said synchronization request on the next selected and indexed channel and returning to step (3).

In another embodiment of the present invention, step (3) further comprises the sub-step of: (a) alternately selecting a response frequency from one or more device hopping tables after receiving a first random hopping frequency from said master device.

In yet another embodiment of the present invention, a first 25 channel profile is calculated by calculating a first 25 frequencies by way of the following formula: f_{first-25}=904.4+i*0.4(MHZ), where i=0,1,2,3, . . . 24; and a second 25 channel profile is calculated by calculating a second 25 frequencies by way of the following formula: f_{second-25}=904.2+j*0.4(MHZ), where j=0,1,2,3, . . . 24, wherein sub-step (b) and (c) populate a first and second 25 channel hopping table.

In a further embodiment of the present invention, the first and second 25 channel hopping tables indicate a busy status, a total time transmitted and an index channel number for each said calculated first and second 25 frequencies.

In yet a further embodiment of the present invention, a 50 channel profile is calculated by calculating 50 frequencies by way of the following formula: f₅₀=904.1+k*0.20(Mhz), where k=0,1,2,3,4, . . . 49; and wherein sub-step (b) populates a 50 channel hopping table.

In yet another embodiment of the present invention, 50 channel hopping table indicate a busy status, a total time transmitted and an index channel number for each said calculated 50 frequencies and said calculated 50 frequencies result in a 50 channel hop sequence is evenly spaced and has a uniform power density.

### BRIEF DESCRIPTION OF THE DRAWINGS

The objects, features and advantages of the present invention will become apparent to one skilled in the art, in view of the following detailed description taken in combination with the attached drawings, in which:

FIG. 1 illustrates a wireless security system deployed in a multi-floored residential home in accordance with one embodiment of the present invention;

FIG. 2 is a block diagram of a frequency hopping spread spectrum communication and control module in accordance with one embodiment of the invention;

FIG. 3 is a timing diagram illustrating an example of a master device synchronizing with a peripheral device in accordance with one embodiment of the present invention;

FIG. 4 is a flow chart showing the synchronization phase and data transfer phase between a master device and peripheral devices having a 25 or 50 channel frequency hopping profile in accordance with one embodiment of the present invention;

FIG. 5 illustrates two 25 and one 50 channel hopping sequences with non-overlapping hopping tables in accordance with one embodiment of the present invention.

### DETAILED DESCRIPTION

A variety of peripheral device types are typically deployed in a wireless network in numerous environments each device type possibly having differing data requirements. For example, a premise wireless alarm or security system includes a master device such as a control panel and a plurality of peripheral sensors (smoke, heat or motion, etc.) as well as keypads and cameras, where each of these peripheral sensors requires different communication ranges and data rates based upon their functional requirement. Security system applications such as audio/video data transmission (e.g. video PIR or alarm verification) might require a short communications range and data transfers at high data rates, while a text based data transmission such as dtmf status or alarm report might require a longer communications range and lower data rates. To accommodate the diversity among peripheral devices types with respect to data rates and communication ranges, the present invention employs the ISM 902-928 Mhz frequency band to allow a master device such as a control panel or network node to communicate with one or more peripheral devices on a single transceiver.

Current FCC rules regulate operations in the 902-928 Mhz frequency band and require frequency hopping spread spectrum (FHSS) with specific limits to the number of channels utilized at different transmission power levels. More specifically, according to FCC part 15.247, FHSS systems are limited to frequency hopping and digitally modulated intentional radiators. According to FCC part 15.247, channel carrier frequencies are separated by a minimum of 25 kHz or the 20 dB bandwidth of the hopping channel, whichever is greater. Additionally, hopping tables are required to have a pseudo-randomly ordered list of hopping frequencies and each frequency must be used equally on the average by each transmitter.

In the FCC mandated FHSS system, receivers have input bandwidth(s) that match the hopping channel bandwidth(s) of their corresponding transmitters and shift frequencies in synchronization with the transmitted signals. In particular, according to the FCC rule, if the 20 dB bandwidth of the hopping channel is less than 250 kHz, the system must use at least 50 hopping frequencies and the average time of occupancy on any frequency must not be greater than 0.4 seconds within a 20 second period. On the other hand, if the 20 dB bandwidth of the hopping channel is 250 kHz or greater, the FCC mandated FHSS system must use at least 25 hopping frequencies and the average time of occupancy on any frequency must not be greater than 0.4 seconds within a 10 second period. FCC part 15.247 also requires that the maximum peak output power not exceed the following: 1) 1 watt for systems employing at least 50 hopping channels; and 2) 0.25 watts for systems with at least 25 and less than 50 hopping channels. While the present invention described herein relates to 902-928 Mhz ISM bands, the system, apparatuses and methods described below can be applied in other frequency bands where frequency hopping is used. Moreover, although the present invention discloses an example of implementing multiple FHSS scheme in a security system, the present invention is not so limited and can be applied to other wireless communications networks where communications between a master device and a plurality of peripheral devices take into account the individual data transmission needs of each peripheral device by providing multiple FHSS schemes.

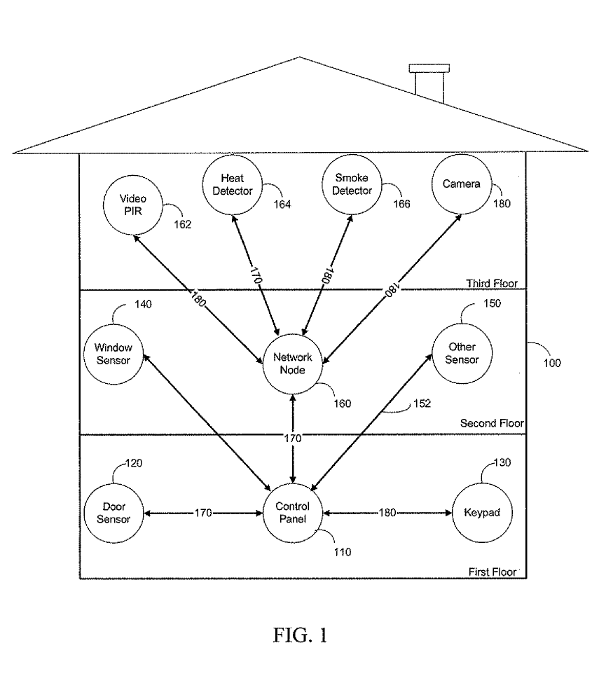

Referring now to FIG. 1, a wireless security system is shown deployed in a multi-floored residential home 100 according to one embodiment of the present invention. It should be noted that the present invention might similarly be deployed in a business environment or other commercial settings as known to those skilled in the art. Moreover, the security network of FIG. 1 is shown in a tree topology however; any other network topology such as a mesh or hybrid topology may be utilized for deployment of peripheral devices.

FIG. 1 depicts a control panel 110 located on the first floor wirelessly communicating with a plethora of peripheral devices such as a first floor door sensor 120 and keypad 130 as well as a second floor window sensor 140 and other sensors 150 (e.g. motion sensor). Also, control panel 110 communicates to a network node 160 located on the second floor or elsewhere in the home wirelessly. The network node 160 can be a hub or switch capable of wireless communications to one or more sensors or keypads.

Moreover, as more thoroughly explained below, the control panel 110 and/or network node 160 may function, as a “master device.” Communications from the master device can be secured by a 25 channel hopping profile 180 or a 50 channel hopping profile, however if a network node is deployed the connection between the control panel 110 and network node 160 must be by way of a 50 channel hopping profile connection 170.

On the third floor, more peripheral devices are shown communicating with the network node 160, such as a Video PIR 162, heat detector 164, a smoke detector 166 and a camera 180. The present invention is not limited to the specific deployment scheme shown in FIG. 1, in fact an overabundance of sensors, keypads and other peripheral devices can be added/subtracted to the wireless security system as known to those skilled in the art. Moreover, other sensor 150 is shown connected to control panel 110 by an undetermined channel hopping profile connection 152 (either 25 or 50 channel hopping profile) to illustrate that the security system is updatable.

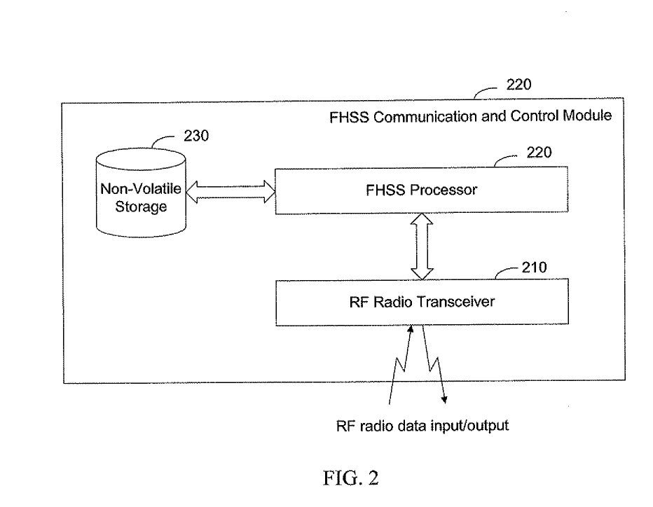

Referring now to FIG. 2, a block diagram of the FHSS communication and control module 200 is shown in accordance with one embodiment of the invention. In order to support wireless communications in the present invention, the control panel 110, network node 160 shown in FIG. 1 and each peripheral device include a radio transceiver 210, FHSS processor 220 such as a microprocessor/controller or a non-volatile storage unit 230. By FCC rule part 15.203, a radio antenna must be permanently attached or utilize a unique coupling. Accordingly, radio transceiver 210 complies with the FCC mandate by permanently attaching a radio antenna for radio data input/output.

Referring now to both FIGS. 1 and 2, it will now be described how the present invention accommodates differences in communication ranges and data rates among peripheral devices while adhering to the FCC mandate. As shown in FIG. 1, the present invention provides at least three FHSS configuration profiles stored in non-volatile storage 230 located in control panel 110, network node 160 and each peripheral device. More specifically, first and second 25 channel hopping profiles and a 50 channel hopping profile, cumulatively encompass a 100 channel dynamic hopping table which is stored in tabular form as depicted in Table 1, 2 and 3 below. In addition, FHSS processor 220 of FIG. 2 contains a means for calculating a dwell time, which as known to those skilled in the art is the period during which a dynamic process remains stable or is halted so that another process may occur. Moreover, as known to those skilled in the art any programming language may be utilized to construct the dynamic information contained in Tables 1-3 below, in non-volatile memory. It should be noted that each peripheral device shown in FIG. 1 includes either a 50 channel hoping profile or both a first and second 25 channel hopping profile.

### 50 Channel Hopping Profile:

In the present invention a 50 channel hopping profile is provided to support wireless communications with peripheral devices that require longer range, and lower data transfer rates. Moreover, the 50 channel hopping profile is provided for communication between control panel 110 and network node 160. Alternatively a peripheral device might for example require a shorter range and higher data rate where the device would uses a 25 channel profile and not a 50 channel profile. For example, a dtmf status or alarm report generated by a smoke detector 166 or heat detector 164 and a graphic keypad 130 as shown in FIG. 1 might require a short communications range and data transfers at high data rates. Therefore, these peripheral devices would employ the 25 channel hopping profile connection as indicated in FIG. 1 by reference character 170 proposed in the present invention. The frequency range as shown below in Table 1 is from a range of 904.1 Mhz to 914.9 Mhz.

TABLE 1
50 Channels Hopping Channel Table:

| | | | | |
|---|---|---|---|---|
| | | | | Total |
| | Pseudorandom | | Busy | Transmit |
| k | Channel Index | Frequency | Status | Time |

| | | |
|---|---|---|
| 0 | 1 | 904.1 |
| 1 | 8 | 904.3 |
| 2 | 32 | 904.5 |
| 3 | 6 | 904.7 |
| 4 | 45 | 904.9 |
| 5 | 33 | 905.1 |
| 6 | 37 | 905.3 |
| 7 | 10 | 905.5 |
| 8 | 36 | 905.7 |
| . . . | . . . | . . . |
| 49 | 5 | 913.9 |

To determine the pseudorandom channel index of Table 1, the following frequency formula is employed:

f₅₀=904.1+k*0.20(Mhz) (Equation No. 1)

In Equation No. 1, k=0,1,2 . . . 49 and the channel spacing is 200 Khz. For example, to determine the pseudorandom channel index of the 5^{th} frequency, the 50 channel hoping profile calculates f₅₀=904.1+5*0.20=905.1 Mhz or in the case of the 50^{th} frequency, f₅₀=904.1+49 *0.20=913.9 Mhz.

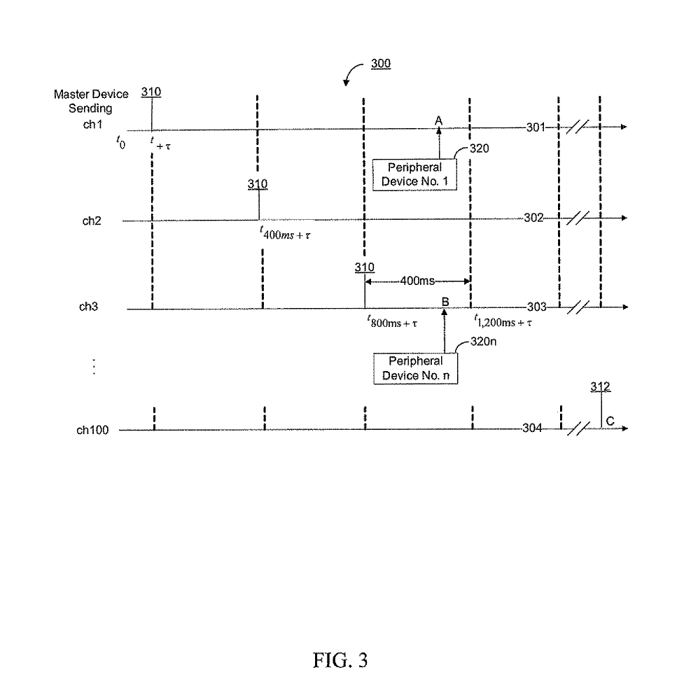

Moreover, as explained below in reference to FIGS. 3 & 4, columns labeled “Busy Status” and “Total Transmission Time” are dynamically updated during the course of the master device's synchronization with each peripheral device in the security network and resulting data transfer. Busy Status simply indicates that a given frequency is currently in use signifying that the master device should move on to the next channel. Total transmission time is the accumulation of transmit time on a particular channel within every 400 ms of a dwell timer as mandated by FCC part 15.247. As known to those skilled in the art other adaptations of the dwell time may be employed.

### 25 Channel Hopping Profile

For peripheral devices requiring shorter communications range and high data rates, two 25 channel hopping profiles are provided. Each 25 channel hopping profile supports a 0.25 Watt transmit power, 25 channels with a channel space is 400 Khz and a frequency range is 905.1-914.7 Mhz and Data rate 140kbps. For example, to support textual/audio/video based data transmission such as dtmf status or alarm report generated by such peripheral devices as a wireless PIR motion detector with video capability and other alarm verification reporting devices. Accordingly, in the present invention a peripheral device utilizes the first 25 channel hopping profile after one channel hopping sequence then utilizes a second 25 channel hopping profile and thereafter alternate between the two tables.

### First 25 Channel Hopping Profile

As shown below in Table 2, a first 25 channel hopping table is shown within the frequency range 904.4 Mhz to 914 Mhz.

TABLE 2
First 25 Channels Hopping Table

| | | | | |
|---|---|---|---|---|
| | | | | Total |
| | Channel | | | Transmit |
| i | Index | Frequency | Busy Status | Time |

| | | |
|---|---|---|
| 0 | 1 | 904.4 |
| 1 | 25 | 904.8 |
| 2 | 18 | 905.2 |
| 3 | 2 | 905.6 |
| 4 | 18 | 906 |
| 5 | 23 | 906.4 |
| 6 | 17 | 906.8 |
| 7 | 10 | 907.2 |
| 8 | 9 | 907.6 |
| . . . | . . . | . . . |
| 24 | 19 | 914 |

To determine the pseudorandom channel index of Table 2, the following frequency formula is employed:

f_{first-25}=904.4+i*0.4(Mhz) (Equation No. 2)

In Equation No. 2, i=0 1, 2, . . . 49 and the channel spacing is 400 Khz. For example, to determine the pseudorandom channel index of the 5^{th} frequency, the 25 channel hoping profile calculates f_{first-25}=904.4+5*0.4(Mhz)=906.4 Mhz or in the case of the 25^{th} frequency, f_{first-25}=904.4+24*0.4(Mhz)=914 Mhz.

As noted above in reference to Table 1, Table 2 similarly provides columns labeled “Busy Status” and “Total Transmission Time” for dynamically updating previously used channel indexes on the peripheral device for the purposes of calculating an alternating switch pattern between Tables 2 & 3 which is updated during the course of the master device's synchronization with each peripheral device in the alarm or security network and resulting data transfer.

TABLE 2
25 Channels Hop Table 2

| | | | | |
|---|---|---|---|---|
| | | | | Total |
| | Channel | | | Transmit |
| j | Index | Frequency | Busy Status | Time |

| | | |
|---|---|---|
| 0 | 1 | 904.2 |
| 1 | 25 | 904.6 |
| 2 | 18 | 905 |
| 3 | 2 | 905.4 |
| 4 | 18 | 905.8 |
| 5 | 23 | 906.2 |
| 6 | 17 | 906.6 |
| 7 | 10 | 907 |
| 8 | 9 | 907.4 |
| . . . | | . . . |
| 24 | 19 | 913.8 |

To determine the pseudorandom channel index of Table 3, the following frequency formula is employed:

f_{second-25}=904.2+j*0.4(Mhz) (Equation No. 3)

In Equation No. 3, j=0 1, 2, . . . 49 and the channel spacing is 400 Khz. For example, to determine the pseudorandom channel index of the 5^{th} frequency, the 25 channel hoping profile calculates f_{second-25}=904.2+5*0.4(Mhz)=906.2 Mhz or in the case of the 25^{th} frequency, f_{second-25}=904.2+24*0.4(Mhz)=913.8 Mhz.

As indicated above columns labeled “Busy Status” and “Total Transmission Time” in Table 3 are dynamically updated during the course of the master device's synchronization with each peripheral device in the alarm or security network and resulting data transfer and aid in the calculation of generating an alternating switching pattern between Tables 2 & 3.

Each of the above described 25 and 50 channel hopping profiles is provided only as an illustration of channel planning for both 50 channels and 25 channels hopping tables which will co-exist within one frequency hopping system without interfering with each other. It is therefore not meant to limit the present invention to the three specific profiles shown in Tables 1-3.

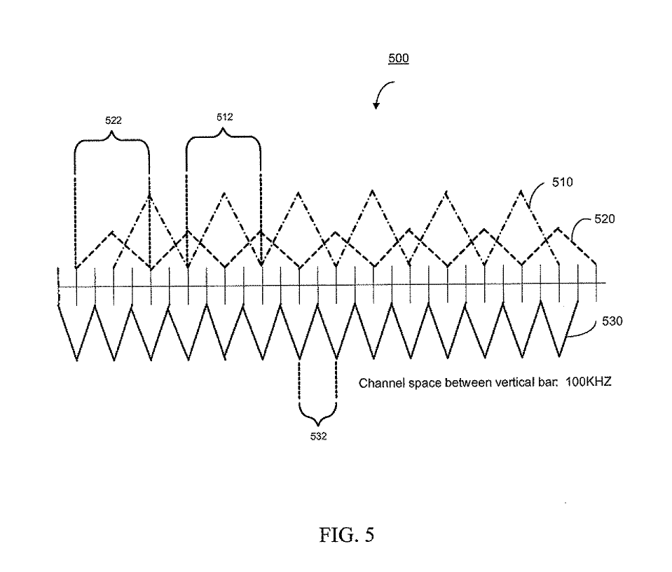

Moreover, as shown in FIG. 5, the above 50 channel hopping table shown in Table 1 does not overlap with the following first and second 25 channel hopping tables described below. For example, the first 25 channel hopping sequence 510 is offset by 100 Khz having a channel spacing of 400 Khz 512 while the second 25 channel hopping sequence 520 is offset by 400 Khz having a similar channel spacing of 400 Khz 522. The 50 channel hopping sequence 530 as shown in FIG. 5 has a channel spacing of 200 Khz. Therefore, 50 channels hopping will not interfere with 25 channels hopping. Overall, the system will be utilizing 100 channels across the frequency band of 904.1-914.

Now the method of operation of the master device shall be described in reference to FIGS. 3 & 4 embodying one example of the present invention. Before describing the operation of present invention, it is important to understand the operational phases of a frequency hopping scheme, device classifications and the interrelation among components in the network. It should be noted that the present invention, like most frequency hopping schemes employs two phases of operation, a synchronization phase and a data transfer phase. Moreover, as discussed above peripheral devices in the present invention are classified into two categories, either 25 channels devices or 50 channels devices. In addition, as mentioned earlier, a master device, which is either control panel 110 or network node 160 has to perform both 25 channels and 50 channels hopping.

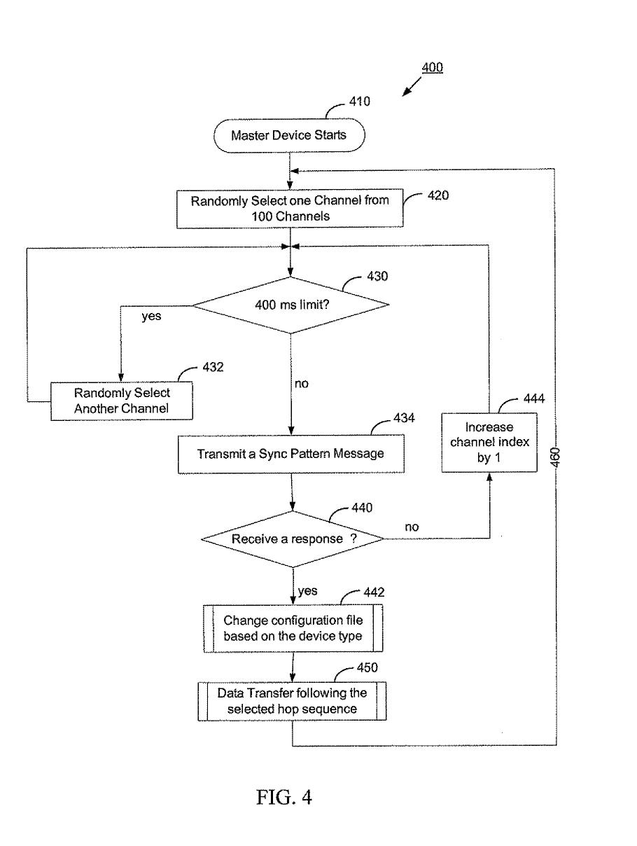

Referring now to FIG. 4, during the initial synchronization process, a master device will send a sync pattern message on all 100 channels as shown in step 410. The master device will first randomly select one channel from the 100 channels as shown in step 420. Each 25 channels peripheral devices will listen to the channels which belong to 25 channel hop table (either Table 2 or 3) while 50 channels peripheral devices will listen to the channels which belong to 50 channel hop table (Table 1). The dwell timer as described above as located in the FHSS processor 220 of FIG. 2, as shown in step 430 of FIG. 4 provides a slot of time whereby any peripheral device may have an opportunity to generate a response. However, as indicated in step 432 if the time slot expires the master device will randomly select another hopping channel. In step 440, the master device determines if a response has been received from any peripheral device.

Once one of peripheral devices receives a sync pattern message, it will send a response to the master device with a device type on the same channel where it receives the sync pattern message as indicated in step 442. After the master device knows the device type, it will follow either 25 channel hop sequence or 50 channel hop sequence, communicating with this particular peripheral device for data transfer. Before entering data transfer phase, as indicated in step 450, both master device and the peripheral device will adjust data rate and transmit power according to 25 channels or 50 channels configuration file. Finally, as indicated in loop 460, after data transfer is completed the channel is released and the master device's hopping table is again updated. After one peripheral device is serviced, master device will start another synchronization process as described above.

Referring now to FIG. 3 a timing diagram is shown further illustrating an example of a master device synchronizing with one or more peripheral devices 300 in accordance with one possible embodiment of the present invention. As shown in FIG. 3, a delay τ is introduced into the synchronous communications between the master device and one or more peripheral devices and to determine a listening slot for a synch message 310 of each channel. For example, on channel 1 (301), the master device sends a sync message 310 at t_{+τ} terminating at t_{400ms+τ}. Since no peripheral device is listening between that specific time slot the master device randomly selects another channel as indicated in step 432 in FIG. 4. That is, depict the fact that peripheral device No. 1 (320) is listening at time slot interval t_{800ms+τ} to t_{1,200ms+τ} at position A, no data is transferred between the master device and the peripheral device No. 1 (320). However, at the same time interval, peripheral device No. n at location B happens to be listening to channel 3. Since the master device is transmitting a sync message 310 at this time slot, peripheral device No. n can transmit a response. After this, peripheral device No. n and the master device can start data transfer phase. This synchronization process will continue till one peripheral device receives a sync pattern message and transmit a response.

In one embodiment of the present invention each channel will be only in transmission for 400 ms as maximum during every 10 seconds or 20 seconds period. As far as channel utilization, the present invention provides for the case where the number of peripheral devices with 50 channels hopping outweighs the number of 25 channels devices. In that instance, 50 channels in Table 1 will be heavily used. However, the present invention can schedule channel utilization as even as possible by using two 25 channels hopping tables for 50 channel hopping as well. Moreover, in order to implement configurable hopping algorithm, hopping tables will store channel usage (channel accumulated transmit time within every 400 ms dwell time period) for each channel. This way, it will help to schedule channel utilization besides random selection of each channel.

Hence, the above described invention provides a novel system, method and apparatus need for providing a configurable frequency hopping system and method that will accord with FCC mandated FHSS schemes that will allow different sensor and keypads types communicate to a control panel or network node in the 902-928 Mhz frequency band on a single transceiver.

The present invention or aspects of the invention can also be embodied in a computer program product, which comprises all the respective features enabling the implementation of the methods described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

While there has been shown and described what is considered to be preferred embodiments of the invention, it will, of course, be understood that various modifications and changes in form or detail could readily be made without departing from the spirit of the invention. It is therefore intended that the scope of the invention not be limited to the exact forms described and illustrated, but should be construed to cover all modifications that may fall within the scope of the appended claims.

What is claimed is:

1. A configurable frequency hopping system (FHSS) for securing communications in a wireless network comprising
a master device;
and a plurality of peripheral devices,
wherein the master device and each plurality of peripheral devices includes a plurality of FHSS profiles, including a plurality of channel having a channel spacing, a data rate, a frequency range, and a transmission power and a FHSS determining unit for selecting an individual FHSS profile from said plurality of FHSS profiles according to a data type and a required data rate of each said peripheral device and a communication range between said master device and each said plurality of peripheral devices, the selection of said individual FHSS profile determines a communication path between the master device and each said plurality of peripheral devices.

2. The system of claim 1, wherein the channel spacing, the data rate, the frequency range, and the transmission power of each said plurality of FHSS profile includes a first FHSS profile configured to include a first plurality of channels and to operate within a first channel spacing scheme in a first frequency range of with a first data rate, and a first transmission power.

3. The system of claim 2, further including a second FHSS profile wherein the channel spacing, the predetermined data rate, the frequency range, and the transmission power of said second FHSS profile are configured to include second plurality of channels and to operate within a second channel spacing scheme in a second frequency range with a second data rate, a second transmission power.

4. The system of claim 1, wherein the first FHSS profile provides for securing one or more text messages, and/or video and/or audio files communicated between at least one master device and a plurality of peripheral devices at shorter communication ranges and at higher data rates.

5. The system of claim 1, wherein the second FHSS profile provides for securing one or more text messages communicated between at least one master device and a plurality of peripheral devices at longer ranges and lower data rates than said second FHSS profile.

6. A configurable frequency hopping (FHSS) method for securing communication between a master device and a plurality of peripheral devices in a security network, comprising the steps of.
(1) randomly selecting and indexing a channel from among plurality of channels contained in a master hopping table in said master device, wherein each said channel is mapped to a plurality of predetermined frequencies contained in said master hopping table;
(2) initializing a transmission of a synchronization request from said master device to each said plurality of peripheral devices according to a predetermined dwell time by transmitting the randomly selected and indexed channel to each said plurality of peripheral devices, wherein if said randomly selected and indexed channel is busy or if said predetermined dwell time elapse updating said master hopping list and incrementing said randomly selected and index channel and transmitting said synchronization request on the randomly selected and indexed incremented channel;
(3) selectively, listening to the said plurality of predetermined channels contained in each peripheral device's hopping table by each said plurality of peripheral devices and identifying if said randomly selected and indexed transmitted channel has sync pattern message from the said master device;
(4) transmitting a response to said transmitted synchronization request, by each said identified plurality of peripheral devices by sending a device type to said master device, wherein said master device identifies said device type and updates hopping sequence in said master hopping table based upon a data type in each said plurality of identified peripheral devices; and
(5) adjusting a data transfer rate between said master device and each said plurality of responding peripheral devices, by said master device
(6) incrementing said selected and indexed channel from said master hopping table and retransmitting said synchronization request on the next selected and indexed channel and returning to step (3).

7. The method as in claim 6, wherein, step (3) further comprises the sub-step of:
(a) alternately selecting a hopping frequency from one or more device hopping tables after receiving a first random hopping frequency from said master device.

8. The method as in claim 7, further comprising the step of:
(b) determining a first 25 channel profile by calculating a first 25 frequencies by way of the following formula:
f_{first-25}904.4+i*0.4(MHZ), where i=0,1,2,3, . . . 24; and
(c) determining a second 25 channel profile by calculating a second 25 frequencies by way of the following formula:
f_{second-25}=904.2+j*0.4(MHZ), where i=0,1,2,3, . . . 24,
wherein sub-step (b) and (c) populate a first and second 25 channel hopping table.

9. The method as in claim 8, wherein said first and second 25 channel hopping tables indicate a busy status, a total time transmitted and an index channel number for each said calculated first and second 25 frequencies.

10. The method as in claim 9, further comprising the step of:
(d) determining a 50 channel profile by calculating 50 frequencies by way of the following formula:
f₅₀=904.1+k*0.20(Mhz), where k=0,1,2,3, . . . 49; and
wherein sub-step (b) populates a 50 channel hopping table.

11. The method as in claim 10, wherein said 50 channel hopping table indicate a busy status, a total time transmitted and an index channel number for each said calculated 50 frequencies.

12. The method as in claim 10, wherein said calculated 50 frequencies result in a 50 channel hop sequence is evenly spaced and has a uniform power density.

13. The method as in claim 9, wherein said calculated first 25 frequencies result in a first 25 channel hop sequence and said calculated second 25 frequencies result in a second 25 channel hop sequence.

14. The method as in claim 13, wherein said calculated first and second 25 channel hop sequences do not overlap.

15. The method as in claim 14, wherein, step (4) further comprises the sub-step of:
updating said master hopping table of said busy status and total transmition time of each said plurality of identified peripheral devices.

16. The method of claim 15, wherein, said plurality of identified peripheral devices contains either a first and second 25 channel hop table or a 50 channel hop table and hop tables are determined by said device type.

17. A program storage device readable by a machine, tangibly embodying a program of instructions executable by the machine to perform a method for providing a configurable frequency hopping (FHSS) method to securing communicating between a master device and a plurality of peripheral devices in a security network, comprising:
a process for randomly selecting and indexing a channel from among plurality of channels contained in a master hopping table in said master device, wherein each said channel is mapped to a plurality of predetermined frequency contained in said master hopping table in the master device;
a process for initializing a transmission of a synchronization request, by said master device between said master device and each said plurality of peripheral devices in the security network according to a predetermined dwell time, wherein if said selected and indexed channel is busy, updating said master hoping list and incrementing said selected and indexed channel or upon elapse of said predetermined dwell time incrementing said selected and indexed channel and transmitting said synchronization request on the selected and indexed channel;
a process for selectively, listening to said plurality of predetermined channels contained in each said plurality of peripheral device's hopping table by each said plurality of peripheral devices and identifying if said randomly selected and indexed transmitted channel has said sync message from said master devices;
a process for transmitting a response to said transmitted synchronization request, by each said identified plurality of peripheral devices by sending a device type to said master device, wherein said master device identifies said device type and updates said master hopping table based upon a data in each said plurality of identified peripheral devices; and
a process for adjusting a data transfer rate between said master device and each said plurality of responding peripheral devices, by said master device, based upon said updated master hoping table;
a process for incrementing said selected and indexed channel in said master hopping table and retransmitting said synchronization request on the next selected and indexed channel and returning to process of selectively, listening to a subset of said plurality of predetermined channels contained in said master hopping table.
